(19) United States
(12) Patent Application Publication
(10) Pub. No.: US 2020/0250578 A1
(43) Pub. Date: Aug. 6, 2020

(54) COMPUTER, METHOD OF GENERATING LEARNING DATA, AND COMPUTER SYSTEM

(71) Applicant: HITACHI, LTD., Tokyo (JP)

(72) Inventors: Ryosuke ODATE, Tokyo (JP); Hiroshi SHINJO, Tokyo (JP); Kenta TAKANOHASHI, Tokyo (JP); Naoyuki TERASHITA, Tokyo (JP)

(73) Assignee: HITACHI, LTD., Tokyo (JP)

(21) Appl. No.: 16/564,614

(22) Filed: Sep. 9, 2019

(30) Foreign Application Priority Data
Feb. 1, 2019 (JP) 2019-017169

(51) Int. Cl. G06N 20/00

(52) U.S. Cl. CPC G06N 20/00

(57) ABSTRACT

A computer, which is configured to generate learning data for use in machine learning for generating model information to be set to a system that is configured to generate second output data from first output data, the first output data being generated by processing input data with use of the model information, the computer being configured to: obtain analysis input data; generate, from the analysis input data, first to-be-analyzed output data based on an arbitrary generation condition; generate second to-be-analyzed output data from the first to-be-analyzed output data; analyze the second to-be-analyzed output data; and generate, as the learning data, data including the analysis input data and the first to-be-analyzed output data in a case where the second to-be-analyzed output data fulfills a user's demand.

### CLAIM OF PRIORITY

The present application claims priority from Japanese patent application JP 2019-017169 filed on Feb. 1, 2019, the content of which is hereby incorporated by reference into this application.

### BACKGROUND OF THE INVENTION

This invention relates to a technology for generating learning data to be used in machine learning.

With the spread of machine learning technology, automation of work that involves recognition, checking, or other types of operation conducted by a person is being advanced. For instance, the reading of a ledger sheet is automated by making use of image processing that uses machine learning technology, and of OCR.

Identification processing using machine learning technology is divided into two phases, namely, 1) learning by an identifier that uses learning data collected in advance (model information) and (2) identification of input executed by using the identifier that has finished learning. Identification precision is determined by the learning of (1). The number and quality of pieces of learning data, in particular, is one of elements that significantly affect identification precision.

The learning data is described taking image processing that uses machine learning technology as an example. The learning data is data including example data and teacher data, which indicates the correct result of image processing. The example data of machine learning in, for example, character identification processing, is an image including a character string, or the like, and the teacher data in character identification processing is character codes of characters that form the character string included in the image, or the like. In the case of image processing, the example data is a raw image that is obtained by photographing, scanning, or the like, and the teacher data is an image that is processed to acquire a desired ideal state by processing the example data, or the like.

The quality of the learning data is measured by the diversity of the example data, the accuracy of the teacher data, and other factors.

Machine learning generally requires a large amount of learning data. The teacher data is manually created in many cases, and enhancement in the efficiency of teacher data creation is an object to be attained because manual creation of the teacher data requires a lot of cost and time. A technology described in JP 2018-148367 A is known as a technology for attaining the object.

In JP 2018-148367 A, there is described an “image processing apparatus configured to generate a determiner for image recognition, the image processing apparatus including: generation means for generating, based on a first picked up image, first learning data, which indicates a first learning image and an image recognition result of the first learning image; and learning means for generating the determiner based on both of the first learning data and second learning data, which is prepared in advance and which indicates a second learning image and an image recognition result of the second learning image, through learning that uses the first learning data.”

The use of the technology described in JP 2018-148367 A helps to reduce the cost and time required to generate the learning data.

### SUMMARY OF THE INVENTION

The technology described in JP 2018-148367 A uses, as the teacher data, an image recognition result that is a processing result of the determiner, without modifying the image recognition result.

In the case of image processing including processing that uses a processing result of the determiner, learning data that contributes to improvement in processing precision cannot always be generated with the technology described in JP 2018-148367 A. This is because, in JP 2018-148367 A, there is no consideration on whether the ultimate result fulfills a user's demand.

The overall precision of the processing accordingly drops when a processing result of the determiner that fails to fulfill the user's demand with the ultimate result is set as the teacher data.

It is therefore an object of the present invention to provide a computer, a method, and a system, which efficiently generate learning data for implementing an identifier capable of yielding an ultimate result that fulfills a user's demand (for generating model information).

A representative example of the present invention disclosed in this specification is as follows: a computer, which is configured to generate learning data for use in machine learning for generating model information to be set to a system that is configured to generate second output data from first output data, the first output data being generated by processing input data with use of the model information, the computer including a processor, a storage device to be coupled to the processor, and an interface to be coupled to the processor, the processor being configured to: obtain analysis input data;

generate, from the analysis input data, first to-be-analyzed output data based on an arbitrary generation condition; generate second to-be-analyzed output data from the first to-be-analyzed output data; analyze the second to-be-analyzed output data; and generate, as the learning data, data including the analysis input data and the first to-be-analyzed output data in a case where the second to-be-analyzed output data fulfills a user's demand.

According to the present invention, the learning data for generating model information capable of yielding the ultimate result (second output data) that fulfills the user's demand can be efficiently generated. Other problems, configurations, and effects than those described above will become apparent in the descriptions of embodiments below.

### BRIEF DESCRIPTION OF THE DRAWINGS

The present invention can be appreciated by the description which follows in conjunction with the following figures, wherein:

FIG. 1 is a diagram for illustrating a configuration example of a computer according to the first embodiment;

FIG. 2 is a diagram for illustrating the flow of processing that is executed by the computer according to the first embodiment;

FIG. 3 is a diagram for illustrating the flow of processing that is executed by the computer according to the first embodiment to generate candidate teacher data;

FIG. 4 is a flow chart for illustrating an example of processing that is executed by the computer according to the first embodiment;

FIG. 5 is a diagram for illustrating a configuration example of the computer according to the second embodiment;

FIG. 6 is a table for showing an example of a data structure of model management information of the second embodiment;

FIG. 7 is a table for showing an example of a data structure of learning data management information of the second embodiment; FIG. 8 is a table for showing an example of a data structure of image processing result information of the second embodiment;

FIG. 9 is a table for showing an example of a data structure of evaluation data management information of the second embodiment;

FIG. 10 is a table for showing an example of a data structure of candidate teacher data management information of the second embodiment;

FIG. 11A and FIG. 11B are flow charts for illustrating processing that is executed by the computer according to the second embodiment;

FIG. 12 is a diagram for illustrating the flow of processing that is executed by the computer according to the second embodiment to generate candidate teacher data;

FIG. 13 is a diagram for illustrating an example of the candidate teacher data that is generated by the computer according to the second embodiment;

FIG. 14 is a diagram for illustrating an example of a check screen that is displayed on the computer according to the second embodiment;

FIG. 15 is a flow chart for illustrating setting processing, which is executed by the computer according to the second embodiment; and

FIG. 16 is a flow chart for illustrating degradation evaluation processing, which is executed by the computer according to the second embodiment.

### DETAILED DESCRIPTION OF THE PREFERRED EMBODIMENTS

Now, an embodiment of this invention is described with reference to the accompanying drawings.

In the drawings for illustrating the embodiment, portions having the same function are denoted by the same reference symbol, and duplicate descriptions thereof are omitted. The embodiment described herein does not limit the invention as defined in the appended claims. Not all of components described in the embodiment and combinations thereof are always indispensable for solutions of this invention.

In the following description, an expression of “xxx table” is sometimes used as an example of information, but any kind of data structure of information may be used. In other words, in order to indicate that the information does not depend on the data structure, the “xxx table” may be paraphrased as “xxx information”. In the following description, a structure of each table is merely an example, and one table may be divided into at least two tables, or all or a part of at least two tables may be combined into one table.

### First Embodiment

An outline of this invention is described in a first embodiment of this invention.

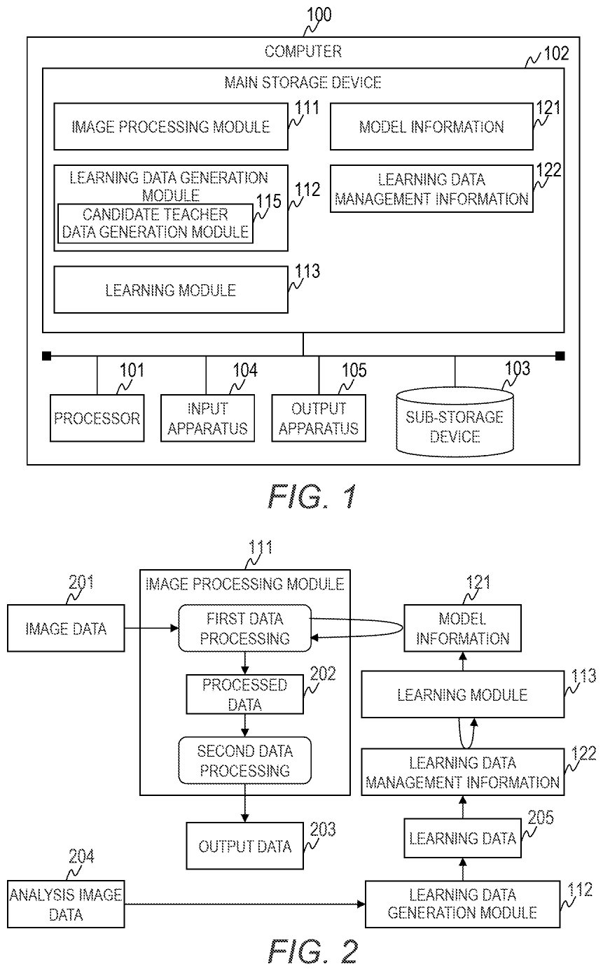

FIG. 1 is a diagram for illustrating a configuration example of a computer according to the first embodiment. FIG. 2 is a diagram for illustrating the flow of processing that is executed by a computer 100 according to the first embodiment. FIG. 3 is a diagram for illustrating the flow of processing that is executed by the computer 100 according to the first embodiment to generate candidate teacher data.

The computer 100 includes a processor 101, a main storage device 102, a sub-storage device 103, an input apparatus 104, and an output apparatus 105.

The pieces of hardware are connected to one another via an internal bus or the like.

The computer 100 has one piece of each type of hardware in FIG. 1, but may have two or more pieces of each type of hardware. The computer 100 may also include a network interface for coupling to a network. The network to be coupled to is not limited to a specific type of network.

The processor 101 executes a program stored in the main storage device 102. The processor 101 operates as a module (function module) implementing a specific function by executing processing as programmed by the program. In the following description, a sentence describing processing with a module as the subject of the sentence means that the processor 101 executes a program for implementing the module.

The main storage device 102 stores a program executed by the processor 101 and information used by the program. The main storage device 102 also includes a work area used temporarily by the program. The main storage device 102 is, for example, a memory.

The main storage device 102 is only required to store programs for implementing some of required modules, and is not required to store programs and information for implementing all modules.

The sub-storage device 103 stores data on a permanent basis. The sub-storage device 103 may be, for example, a hard disk drive (HDD) or a solid state drive (SSD). A program and information to be stored in the main storage device 102 may be stored in the sub-storage device 103. In this case, the processor 101 reads the program and the information out of the sub-storage device 103, and loads the read program and information onto the main-storage device 102.

The input apparatus 104 is an apparatus for inputting data to the computer 100. For example, the input apparatus 104 includes one or more of a keyboard, a mouse, a touch panel, and other pieces of equipment for operating the computer. The input apparatus 104 also includes one or more of a scanner, a digital camera, a smartphone, and other pieces of equipment for obtaining image data.

The output apparatus 105 is an apparatus configured to output a data input screen, a processing result, and the like. The output apparatus 105 includes one or more of a touch panel, a display, and similar pieces of equipment.

Programs and information stored in the main storage device 102 are described. The main storage device 102 of the first embodiment stores programs for implementing an image processing module 111, a learning data generation module 112, and a learning module 113. The main storage device 102 also stores model information 121 and learning data management information 122.

The model information 121 is information to be used in processing executed by the image processing module 111. The model information 121 includes, for example, information about the structure of a neural network or a decision tree. Information that is initially set to the computer 100 as the model information 121 may be set manually by a user or may be generated by executing learning processing.

The learning data management information 122 is information for managing learning data 205 illustrated in FIG. 2. The learning data 205 includes example data to be processed by image processing, and ideal data (teacher data) that is obtained by processing the example data.

The image processing module 111 executes image processing on image data 201. Image processing of the first embodiment includes first data processing and second data processing. In the first data processing, processed data 202 is generated by processing the image data 201 based on the model information 121. The first data processing may be, for example, processing described in Chris Tensmeyer and Tony Martinez, “Document Image Binarization with Fully Convolutional Neural Networks”, Proceedings of ICDAR 2017, pp. 99-104, 2017. In the second processing, output data 203 is generated by executing second image processing, in which the processed data 202 is processed.

The image processing described above is an example, and this invention is applicable to image processing that includes at least one data processing procedure in which a result of data processing based on the model information 121 is utilized. For instance, the image processing may include another data processing procedure between the first data processing and the second data processing.

The learning data generation module 112 uses analysis image data 204 to generate the learning data 205, and stores the generated learning data 205 in the learning data management information 122. The learning data generation module 112 includes a candidate teacher data generation module 115.

The candidate teacher data generation module 115 executes third processing on the analysis image data 204 to generate candidate teacher data 301, which is a candidate for the teacher data included in the learning data 205. The candidate teacher data generation module 115 also executes second image processing in which the candidate teacher data 301 is processed, thereby generating to-be-analyzed output data 302 illustrated in FIG. 3.

The third data processing is processing that differs from the first data processing in algorithm. The model information 121 is not used in the third data processing. The processed data 202 and the candidate teacher data 301 are data in the same data format.

The learning module 113 uses the learning data 205 stored in the learning data management information 122 to execute learning processing for generating the model information 121. This invention is not limited by the algorithm of a learning method.

The functions and information included in the computer 100 may be distributed among a plurality of computers connected to one another via a network or directly. For instance, this invention may be embodied by a computer system including a computer that includes the image processing module 111, a computer that includes the learning data generation module 112, and a computer that includes the learning module 113.

This invention is not limited by the type of data handled in this invention. The same effect of this invention is obtained also when the handled data is, for example, text data or data in a CSV format.

An object of the first embodiment is now described.

The teacher data for generating the model information 121 to be used in the image processing illustrated in FIG. 2 is required to be data from which the output data 203 that fulfills the user's demand is obtained. An object of this invention is to generate teacher data that guarantees that the output data 203 fulfills the user's demand.

Examples of the user's demand include the clarity of an output image, and the accuracy and precision of a calculated prediction result or an authentication result.

In order to attain the object described above, the computer 100 generates the candidate teacher data 301, and utilizes the result of analyzing the to-be-analyzed output data 302, which is obtained from the candidate teacher data 301. When the to-be-analyzed output data 302 fulfills the user's demand, the computer 100 determines that the candidate teacher data 301 is appropriate teacher data. In other words, the computer 100 determines the candidate teacher data 301 as appropriate teacher data when ultimately output data fulfills the user's demand.

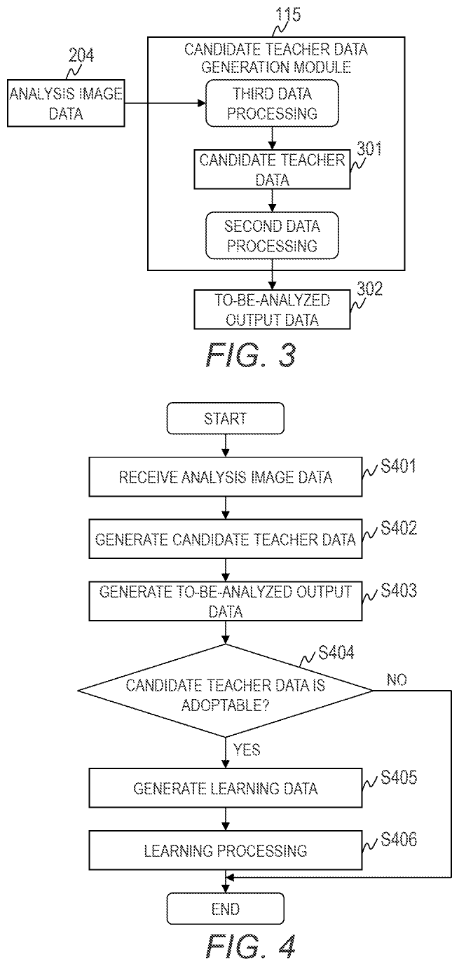

FIG. 4 is a flow chart for illustrating an example of processing that is executed by the computer 100 according to the first embodiment.

The computer 100 receives input of the analysis image data 204 (Step S401). The analysis image data 204 may be data obtained from the input apparatus 104, or may be data obtained from the sub-storage device 103 or an external storage apparatus. One piece of or a plurality of pieces of analysis image data 204 may be input. When a plurality of pieces of analysis image data 204 are input, processing of Step S402 to Step S407 is executed for one piece of analysis image data 204 at a time.

The computer 100 next generates the candidate teacher data 301 from the analysis image data 204 (Step S402), and generates the to-be-analyzed output data 302 from the candidate teacher data 301 (Step S403).

Specifically, the learning data generation module 112 executes the third data processing with the use of the analysis image data 204 to generate the candidate teacher data 301, and executes the second data processing on the candidate teacher data 301 to generate the to-be-analyzed output data 302.

The computer 100 next determines whether the candidate teacher data 301 is adoptable as the teacher data (Step S404).

Specifically, the learning data generation module 112 analyzes the to-be-analyzed output data 302 in terms of accuracy, precision, quality, and the like and, based on the result of the analysis, determines whether the to-be-analyzed output data 302 fulfills the user's demand. When the to-be-analyzed output data 302 fulfills the user's demand, the learning data generation module 112 determines that the candidate teacher data 301 is adoptable as the teacher data.

In a case where it is determined that the candidate teacher data 301 is not adoptable as the teacher data, the computer 100 ends the processing of FIG. 4.

In a case where it is determined that the candidate teacher data 301 is adoptable as the teacher data, the computer 100 generates the learning data 205 (Step S405).

Specifically, the learning data generation module 112 generates the learning data 205, which includes the analysis image data 204 and the candidate teacher data 301. The learning data generation module 112 stores the learning data 205 in the learning data management information 122.

The computer 100 next executes the learning processing (Step S406), and then ends the processing of FIG. 4.

Specifically, the learning module 113 executes the learning processing with the use of the learning data 205 stored in the learning data management information 122, and updates the model information 121. The computer 100 may be configured to execute the learning processing in a case where the number of pieces of learning data 205 stored in the learning data management information 122 is larger than a threshold. The computer 100 may also be configured to execute the learning processing in a case where the number of pieces of learning data 205 generated by the learning data generation module 112 is larger than a threshold.

The processing of Step S402 may be executed after the processing of Step S403 to Step S406 is executed.

The candidate teacher data 301 may be generated from a part of the analysis image data 204. In this case, data including the part of the analysis image data 204 and the candidate teacher data 301 is generated as the learning data 205.

According to the first embodiment, the computer 100 is capable of generating the learning data 205 for generating the model information 121 from which an ultimate processing result that fulfills the user's demand is yielded, in processing that uses output of data processing based on the model information 121.

### Second Embodiment

In a second embodiment of this invention, processing to be executed by the computer 100 is described through a description of specific image processing. The description given below on the second embodiment focuses on differences from the first embodiment.

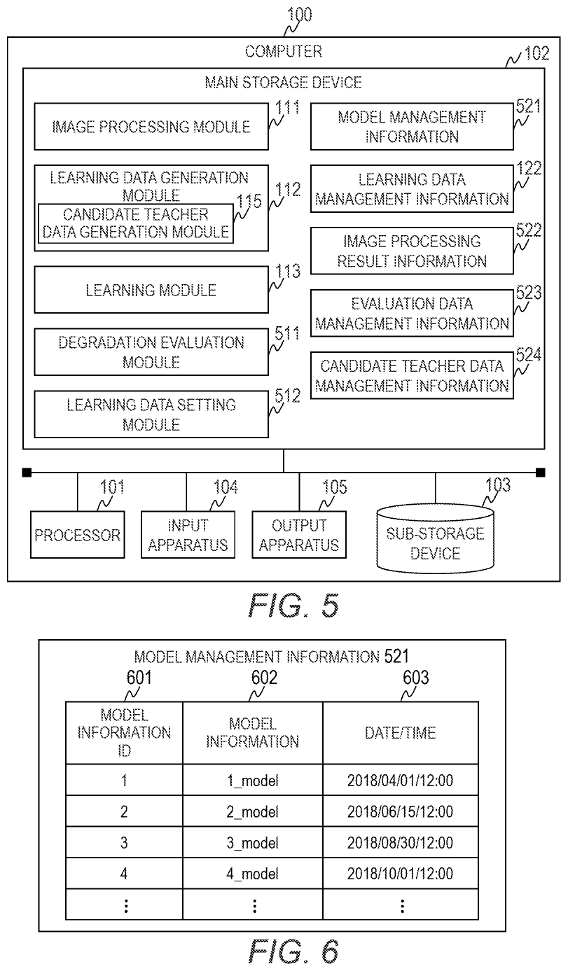

FIG. 5 is a diagram for illustrating a configuration example of the computer 100 according to the second embodiment.

The computer 100 according to the second embodiment has the same hardware configuration as the one in the first embodiment. The software configuration of the computer 100 according to the second embodiment partially differs from the one in the first embodiment.

The computer 100 according to the second embodiment executes character recognition processing as image processing. The character recognition processing includes converting the image data 201 into binary image data, and conducting character recognition on the binary image data. In the image processing of the second embodiment, the accuracy of the result of character string recognition is set as the user's demand for the output data 203. In other words, it is deter mined that the output data 203 fulfills the user's demand in a case where a correct character string is extracted, and it is determined that the output data 203 does not fulfill the user's demand in a case where a wrong character string or an unrecognizable character string is extracted.

The main storage device 102 of the computer 100 according to the second embodiment differs from the main storage device 102 of the first embodiment in that programs for implementing a degradation evaluation module 511 and a learning data setting module 512 are stored. The main storage device 102 of the computer 100 according to the second embodiment also differs from the main storage device 102 of the first embodiment in that model management information 521, image processing result information 522, evaluation data management information 523, and candidate teacher data management information 524 are stored.

In the second embodiment, the image data 201 and the analysis image data 204 that include a character string are input.

The image processing module 111 executes first data processing in which binary image data is generated as the processed data 202 from the image data 201 or the analysis image data 204, and executes second data processing in which character recognition processing using the binary image data is conducted to generate the recognition result as the output data 203.

The candidate teacher data generation module 115 executes third data processing in which binary image data is generated as the candidate teacher data 301 from the analysis image data 204, and executes second data processing in which character recognition processing using the candidate teacher data 301 is conducted to generate the recognition result as the to-be-analyzed output data 302.

The learning module 113 executes learning processing to generate the model information 121 for generating binary image data from the image data 201.

The degradation evaluation module 511 evaluates the degradation of the model information 121 generated by the learning processing.

The learning data setting module 512 generates the learning data 205 based on the user's input when the learning data 205 cannot be generated by the learning data generation module 112.

The model management information 521 is information for managing the model information 121 generated by the learning processing. The generated model information 121 is stored in the model management information 521 as history as described below. Details of a data structure of the model management information 521 are described with reference to FIG. 6.

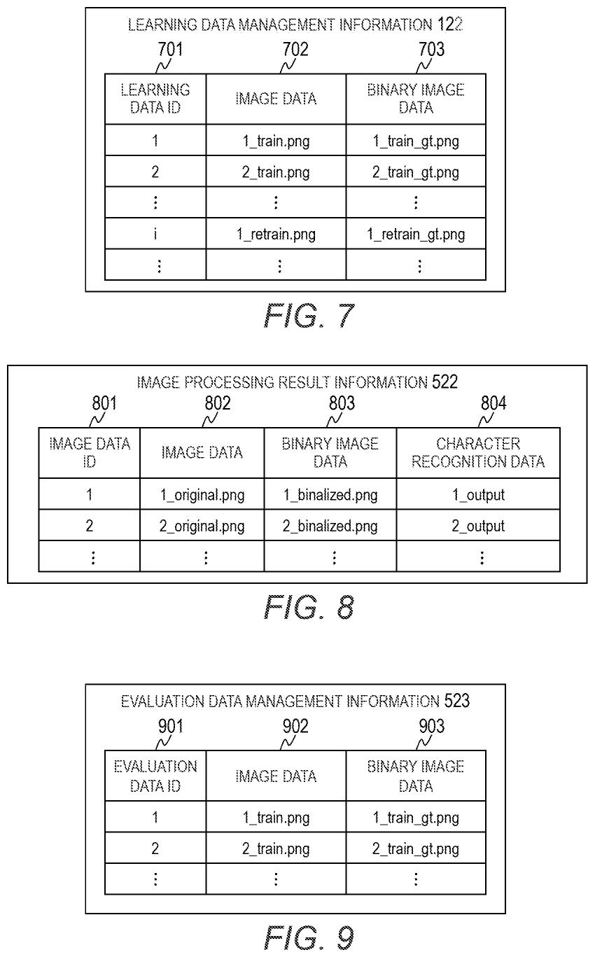

Details of a data structure of the learning data management information 122 are described with reference to FIG. 7.

The image processing result information 522 is information for managing the result of processing executed by the image processing module 111. Details of a data structure of the image processing result information 522 are described with reference to FIG. 8.

The evaluation data management information 523 is information for managing evaluation data used by the degradation evaluation module 511. Details of a data structure of the evaluation data management information 523 are described with reference to FIG. 9. The evaluation data has the same data structure as that of the learning data 205.

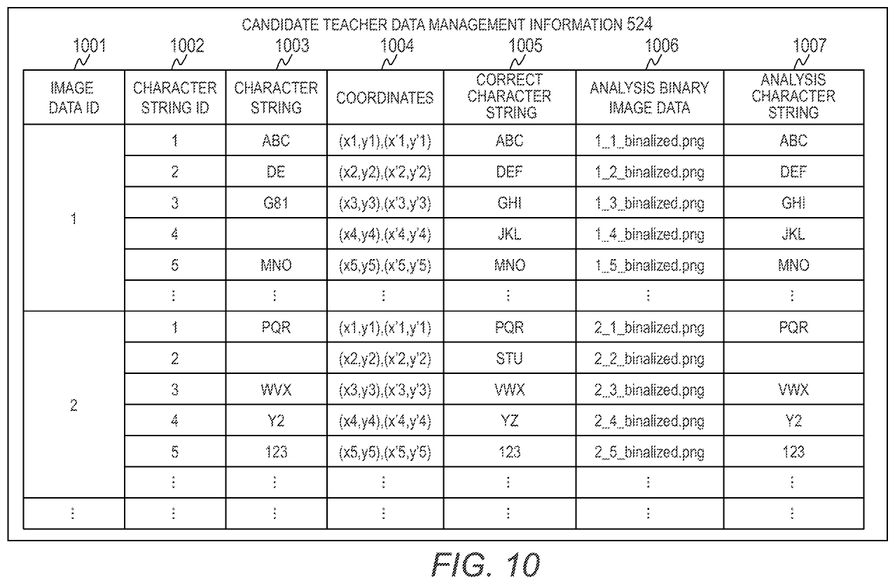

The candidate teacher data management information 524 is information for managing the candidate teacher data 301. Details of a data structure of the candidate teacher data management information 524 are described with reference to FIG. 10.

FIG. 6 is a table for showing an example of the data structure of the model management information 521 of the second embodiment.

The model management information 521 stores entries each including fields for a model information ID 601, model information 602, and a date/time 603. One entry corresponds to one piece of model information 121. The fields included in each entry are an example, and fields other than those given above may be included.

The field for the model information ID 601 stores identification information for uniquely identifying a piece of model information 121.

The field for the model information 602 stores the piece of model information 121. The field for the model information 602 may store a link, a path, or the like that is used to read the piece of model information 121 stored in the sub-storage device 103 or another place.

The field for the date/time 603 stores the date/time of execution of the learning processing for generating the piece of model information 121. The date/time 603 is used as information for identifying the generation of the piece of model information 121. It should be noted that the field for the date/time 603 may be replaced by a field for storing a set of pieces of learning data 205 that have been used, the creator of the piece of model information 121, and the like. This field may be provided in addition to the field for the date/time 603.

FIG. 7 is a table for showing an example of the data structure of the learning data management information 122 of the second embodiment.

The learning data management information 122 stores entries each including fields for a learning data ID 701, image data 702, and binary image data 703. One entry corresponds to one piece of learning data 205. It should be noted that the fields included in each entry are an example, and fields other than those given above may be included.

The field for the learning data ID 701 stores identification information for uniquely identifying a piece of learning data 205.

The field for the image data 702 stores image data that is the example data included in the piece of learning data 205. The field for the image data 702 may store a link, a path, or the like that is used to read the image data stored in the sub-storage device 103 or another place.

The field for the binary image data 703 stores binary image data that is the teacher data. The field for the binary image data 703 may store a link, a path, or the like that is used to read the binary image data stored in the sub-storage device 103 or another place.

A piece of learning data 205 for which “train.png” is stored as the image data 702 is the learning data that is set in advance. A piece of learning data 205 for which “retrain.png” is stored as the image data 702 is the learning data 205 that is generated by the learning data generation module 112 or the learning data setting module 512.

FIG. 8 is a table for showing an example of the data structure of the image processing result information 522 of the second embodiment.

The image processing result information 522 stores entries each including fields for an image data ID 801, image data 802, binary image data 803, and character recognition data 804. One entry is created for one piece of analysis image data 204. The fields included in each entry are an example, and fields other than those given above may be included.

The field for the image data ID 801 stores identification information for uniquely identifying a piece of analysis image data 204.

The field for the image data 802 stores the piece of analysis image data 204. The field for the image data 802 may store a link, a path, or the like that is used to read the piece of analysis image data 204 stored in the sub-storage device 103 or another place.

The field for the binary image data 803 stores binary image data (the processed data 202) generated by executing the first data processing on the piece of analysis image data 204. The field for the binary image data 803 may store a link, a path, or the like that is used to read the binary image data stored in the sub-storage device 103 or another place.

The field for the character recognition data 804 stores character recognition data (the output data 203) generated by executing the second data processing on the binary image data. The character recognition data is data including the result of character recognition. The field for the character recognition data 804 may store a link, a path, or the like that is used to read the character recognition data stored in the sub-storage device 103 or another place.

FIG. 9 is a table for showing an example of the data structure of the evaluation data management information 523 of the second embodiment.

The evaluation data management information 523 contains entries each including fields for an evaluation data ID 901, image data 902, and binary image data 903. One entry corresponds to one piece of evaluation data. The fields included in each entry are an example, and fields other than those given above may be included.

The field for the evaluation data ID 901 stores identification information for uniquely identifying a piece of evaluation data.

The field for the image data 902 stores image data 201 that is used for evaluation. The field for the image data 902 may store a link, a path, or the like that is used to read the image data for evaluation stored in the sub-storage device 103 or another place.

The field for the binary image data 903 stores teacher data that is used for evaluation. The field for the binary image data 903 may store a link, a path, or the like that is used to read the binary image data for evaluation stored in the sub-storage device 103 or another place.

FIG. 10 is a table for showing an example of the data structure of the candidate teacher data management information 524 of the second embodiment.

The candidate teacher data management information 524 contains entries each including fields for an image data ID 1001, a character string ID 1002, a character string 1003, coordinates 1004, a correct character string 1005, analysis binary image data 1006, and an analysis character string 1007. One entry is created for one piece of analysis image data 204.

The field for the image data ID 1001 stores identification information for uniquely identifying a piece of analysis image data 204.

The field for the character string ID 1002 stores identification information of a character string extracted by the image processing. One entry has as many rows as the number of extracted character strings, and each row is identified by the character string ID 1002.

The field for the character string 1003 stores the character string extracted by the image processing. When the extracted character string is unrecognizable, the field for the character string 1003 is left blank.

The field for the coordinates 1004 stores coordinates that indicate the position of the character string in the image. For example, a pair of coordinates indicating the upper left corner of a rectangular area and coordinates indicating the lower right corner of the rectangular area is stored in the field for the coordinates 1004.

The field for the correct character string 1005 stores a character string to be extracted.

The field for the analysis binary image data 1006 stores binary image data generated as the candidate teacher data 301.

The field for the analysis character string 1007 stores the result of character recognition conducted on the binary image data that has been generated as the candidate teacher data 301.

The coordinates 1004 and the correct character string 1005 may be included in meta data of the analysis image data 204, or may manually be set by the user by referring to the result of the image processing.

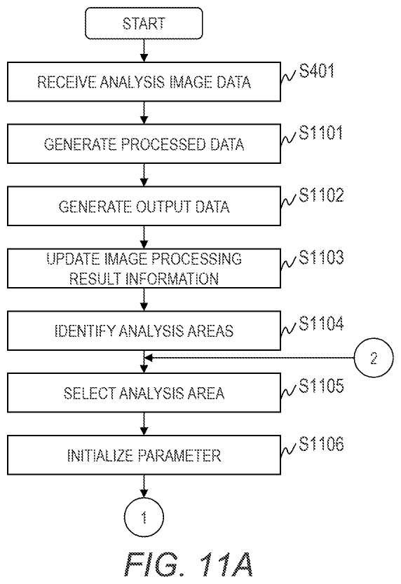

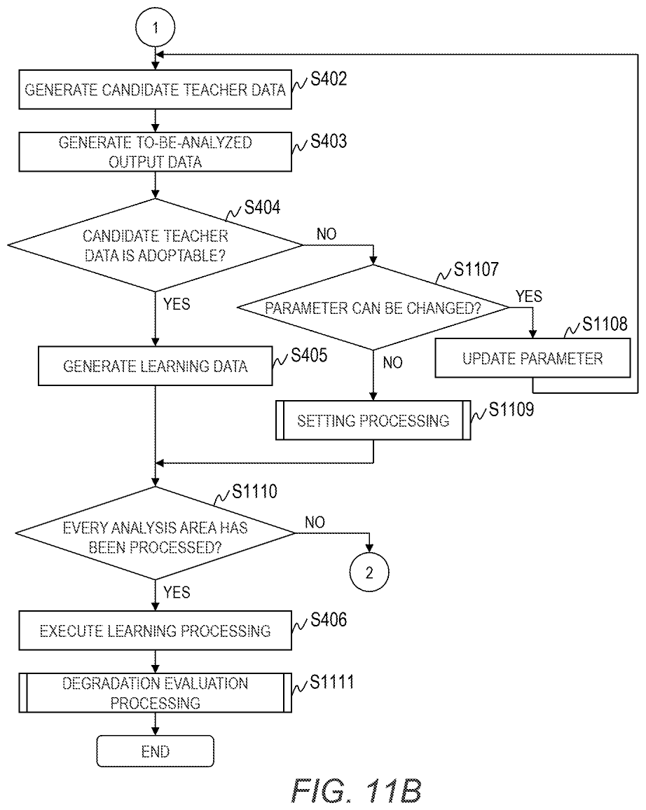

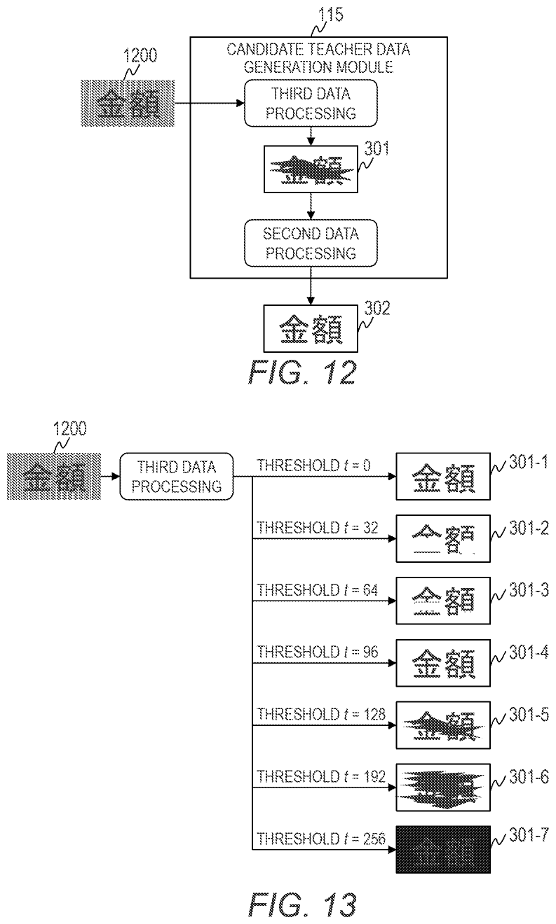

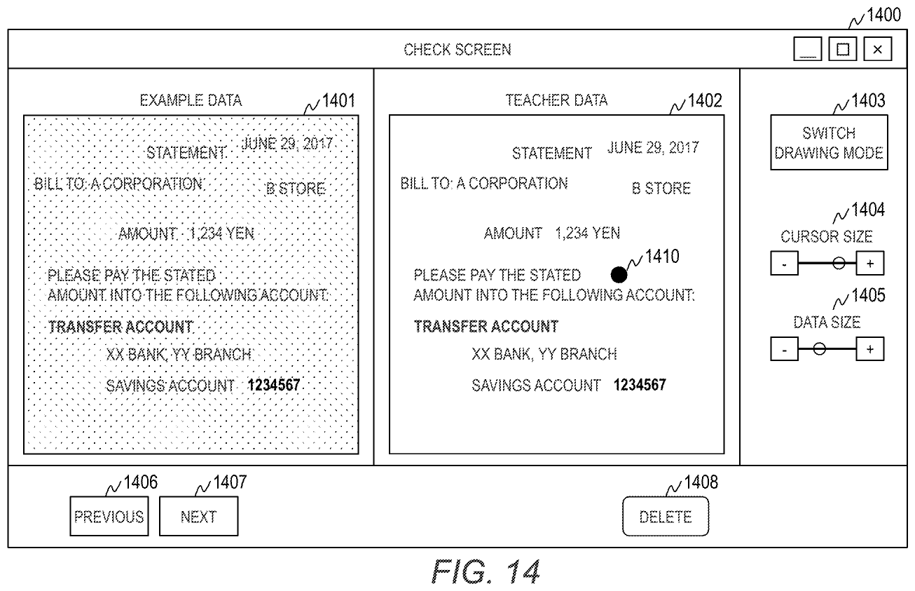

FIG. 11A and FIG. 11B are flow charts for illustrating processing that is executed by the computer 100 according to the second embodiment. FIG. 12 is a diagram for illustrating the flow of processing that is executed by the computer 100 according to the second embodiment to generate candidate teacher data. FIG. 13 is a diagram for illustrating an example of the candidate teacher data that is generated by the computer 100 according to the second embodiment. FIG. 14 is a diagram for illustrating an example of a check screen that is displayed on the computer 100 according to the second embodiment.

The computer 100 receives the analysis image data 204 (Step S401). The meta data of the analysis image data 204 includes at least one pair of the coordinates of an analysis area and a correct character string. It should be noted that one piece of or a plurality of pieces of analysis image data 204 may be input. When a plurality of pieces of analysis image data 204 are input, processing of Step S402 to Step S406 and Step S1101 to Step S1110 is executed for one piece of analysis image data 204 at a time.

The image processing module 111 of the computer 100 next executes the first data processing on the analysis image data 204, to thereby generate binary image data as the processed data 202 (Step S1101), and executes the second data processing on the binary image data, to thereby generate character recognition data as the output data 203 (Step S1102).

The image processing module 111 of the computer 100 next updates the image processing result information 522 (Step S1103).

Specifically, the image processing module 111 adds an entry to the image processing result information 522, and stores identification information of the relevant analysis image data 204 as the image data ID 801 in the added entry. In the added entry, the image processing module 111 also stores the relevant analysis image data 204 as the image data 802, the processed data 202 as the binary image data 803, and the output data 203 as the character recognition data 804.

Next, the learning data generation module 112 of the computer 100 identifies an analysis area (Step S1104). Specifically, processing described below is executed.

The learning data generation module 112 adds an entry to the candidate teacher data management information 524, and stores identification information of the relevant analysis image data 204 as the image data ID 1001 in the added entry.

In the added entry, the learning data generation module 112 generates as many rows as the number of areas for which the character recognition has been conducted, based on the character recognition data that is the output data 203. One row is identified as one analysis area.

The learning data generation module 112 stores values as the character string ID 1002, the character string 1003, and the coordinates 1004 in each of the generated rows, based on the character recognition data.

The learning data generation module 112 refers to the meta data of the analysis image data 204 to store a value as the correct character string 1005 in each row. In the case of manually setting the correct character string 1005, the learning data generation module 112 presents a screen displaying recognition results, and receives input of a character string. This concludes the description on the processing of Step S1104.

The learning data generation module 112 of the computer 100 next selects a target analysis area from the identified analysis areas (Step S1105).

The learning data generation module 112 of the computer 100 next initializes a parameter for adjusting the third data processing (Step S1106).

For example, when an image is turned into binary data by executing threshold processing with respect to luminance, a threshold t is set to 0. The threshold t is variable from 0 to 255. It should be noted that this invention is not limited by how binary image data is generated.

The learning data generation module 112 of the computer 100 next executes the third data processing on an image included in the target analysis area, to thereby generate binary image data as the candidate teacher data 301 (Step S402). rf

For example, when image data 1200 illustrated in FIG. 12, which includes a character string “money amount”, is input, the candidate teacher data generation module 115 generates binary image data illustrated in FIG. 12 as the candidate teacher data 301.

Variations of the candidate teacher data 301 as those illustrated in FIG. 13 are generated by adjusting the threshold t. Candidate teacher data 301-1 is binary image data that is generated when the threshold t is 0. Candidate teacher data 301-2 is binary image data that is generated when the threshold t is 32. Candidate teacher data 301-3 is binary image data that is generated when the threshold t is 64. Candidate teacher data 301-4 is binary image data that is generated when the threshold t is 96. Candidate teacher data 301-5 is binary image data that is generated when the threshold t is 128. Candidate teacher data 301-6 is binary image data that is generated when the threshold t is 192. Candidate teacher data 301-7 is binary image data that is generated when the threshold t is 256.

At this point, the learning data generation module 112 refers to the entry added in Step S1104 to the candidate teacher data management information 524, and stores the generated candidate teacher data 301 as the analysis binary image data 1006 in a row that corresponds to the target analysis area.

The learning data generation module 112 of the computer 100 next executes the second data processing on the candidate teacher data 301, to thereby generate the character recognition data as the to-be-analyzed output data 302 (Step S403).

For example, when image data 1200 illustrated in FIG. 12, which includes a character string “money amount”, is input, the candidate teacher data generation module 115 generates binary image data illustrated in FIG. 12 as the candidate teacher data 301.

At this point, the learning data generation module 112 refers to the entry added in Step S1104 to the candidate teacher data management information 524, and stores the generated to-be-analyzed output data 302 as the analysis character string 1007 in a row that corresponds to the target analysis area.

The learning data generation module 112 of the computer 100 next determines whether the candidate teacher data 301 is adoptable as the teacher data (Step S404).

Specifically, the learning data generation module 112 determines whether a character string stored as the correct character string 1005 and a character string stored as the analysis character string 1007 match in the row corresponding to the target analysis area. When the character string stored as the correct character string 1005 and the character string stored as the analysis character string 1007 match, the learning data generation module 112 determines that the candidate teacher data 301 is adoptable as the teacher data.

The candidate teacher data 301-4 and the candidate teacher data 301-5, for example, are determined as adoptable as the teacher data.

When it is determined that the candidate teacher data 301 is adoptable as the teacher data, the learning data generation module 112 of the computer 100 generates the learning data 205 (Step S405). The computer 100 then proceeds to Step S1110.

Specifically, the learning data generation module 112 generates the learning data 205 that includes the image of the target analysis area and the candidate teacher data 301. The learning data generation module 112 adds an entry to the learning data management information 122, and stores identification information as the learning data ID 701 in the added entry. In the added entry, the learning data generation module 112 also stores the image of the target analysis area as the image data 702, and stores the candidate teacher data 301 as the binary image data 703.

When it is determined that the candidate teacher data 301 is not adoptable as the teacher data, the learning data generation module 112 of the computer 100 determines whether the parameter can be changed (Step S1107).

For example, the learning data generation module 112 determines whether the threshold t is lower than 255. The learning data generation module 112 determines that the parameter can be changed when the threshold t is lower than 255.

When it is determined that the parameter can be changed, the learning data generation module 112 of the computer 100 updates the parameter (Step S1108), and then returns to Step S402.

When it is determined that the parameter cannot be changed, the computer 100 executes setting processing (Step S1109), and then proceeds to Step S1110.

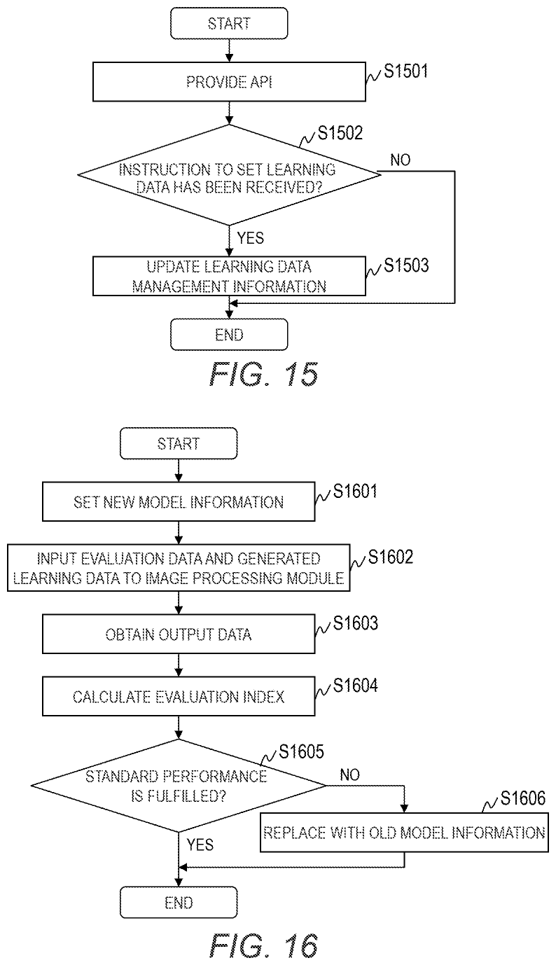

Specifically, the learning data generation module 112 instructs the learning data setting module 512 to execute the setting processing, and shifts to a waiting state. The learning data generation module 112 proceeds to Step S1110 when a completion notification is received from the learning data setting module 512. Details of the setting processing are described with reference to FIG. 15.

In Step S1110, the learning data generation module 112 of the computer 100 determines whether every analysis area has been processed (Step S1110).

When it is determined that not all of the analysis areas have been processed, the learning data generation module 112 of the computer 100 returns to Step S1105.

When it is deter mined that every analysis area has been processed, the learning module 113 of the computer 100 executes the learning processing (Step S406).

The learning module 113 in this step adds an entry to the model management information 521, and stores identification information as the model information ID 601 in the added entry. In the added entry, the learning module 113 also stores a piece of model information 121 generated by the learning processing as the model information 602, and stores the start time or the like of the learning processing as the date/time 603.

Next, the degradation evaluation module 511 of the computer 100 uses evaluation data stored in the evaluation data management information 523 to execute degradation evaluation processing for the generated model information 121 (Step S1111). The computer 100 then ends the processing of FIG. 11A and FIG. 11B.

Specifically, the learning data generation module 112 instructs the degradation evaluation module 511 to execute the degradation evaluation processing, and shifts to a waiting state. The learning data generation module 112 ends the processing of FIG. 11A and FIG. 11B when a completion notification is received from the degradation evaluation module 511. Details of the degradation evaluation processing are described with reference to FIG. 16.

### Variation 1

In the processing described with reference to FIG. 11A and FIG. 11B, one piece of learning data 205 is generated for one analysis area. This invention, however, is not limited thereto.

For instance, the learning data generation module 112 may generate the learning data 205 that includes the analysis image data 204 and data including binary image data of each analysis area. In this case, the processing of Step S405 is executed after the processing of Step S1110.

### Variation 2

In the processing described with reference to FIG. 11A and FIG. 11B, learning data 205 is generated for every analysis area. This invention, however, is not limited thereto.

For instance, the learning data generation module 112 may select only analysis areas for which the character string 1103 and the correct character sting 1005 do not match as areas to be processed. In other words, only analysis areas in which character strings are unrecognizable to the image processing module 111 may be selected as areas to be processed. Learning processing having improved precision and a reduced amount of data to be learned is accomplished by generating the learning data 205 from an analysis area that contains a wrong character string or an unrecognizable character string.

### Variation 3

The computer 100 may display a check screen 1400 for presenting the generated learning data 205 when the result of the determination of Step S1110 is “YES”. The check screen 1400 is described.

The check screen 1400 includes an example data display section 1401, a teacher data display section 1402, a drawing mode switching button 1403, a cursor size adjustment bar 1404, a data size adjustment bar 1405, a previous button 1406, a next button 1407, and a delete button 1408.

The example data display section 1401 is a field in which the example data (the analysis image data 204) included in the learning data 205 is displayed.

The teacher data display section 1402 is a field in which the teacher data (the candidate teacher data 301) included in the learning data 205 is displayed. In the teacher data display section 1502 illustrated in FIG. 14, binary image data (the candidate teacher data 301) generated from each analysis area that is included in the analysis image data 204 is displayed.

A cursor 1410 is displayed in the teacher data display section 1402. The user operates the cursor 1410 to select an area in which binary image data is to be modified, and modifies the binary image data of the selected area. When the content of the modification is received from the user, the learning data generation module 112 identifies an analysis area that is included in the area specified by the user, and updates the analysis binary image data 1006 in a row corresponding to the identified analysis area.

The drawing mode switching button 1403 is a button for switching the drawing mode of the teacher data. Examples of the switching include the operation of switching white and black of the binary image data.

The cursor size adjustment bar 1404 is a bar for adjusting the size of the cursor 1410.

The data size adjustment bar 1405 is a bar for increasing or reducing the example data and the teacher data in size.

The previous button 1406 is a button for displaying the immediately preceding piece of learning data 205. The next button 2407 is a button for displaying the immediately following piece of learning data 205. When one of the previous button 1406 and the next button 1407 is operated, images displayed in the example data display section 1401 and the teacher data display section 1402 are switched.

The delete button 1408 is a button for deleting the learning data 205. When the delete button 1408 is operated, the learning data generation module 112 deletes the piece of learning data 205 that is being displayed on the check screen 1400 from the learning data management information 122.

The check screen 1400 is an example of a display screen, and the display screen is not limited thereto. For instance, the example data and the teacher data may be displayed overlaid in order to emphasize a difference between the example data and the teacher data.

FIG. 15 is a flow chart for illustrating the setting processing, which is executed by the computer 100 according to the second embodiment.

The learning data setting module 512 provides an application programming interface (API) for receiving the user's settings of the learning data 205 (Step S1501). For example, the screen illustrated in FIG. 14 is displayed on the input apparatus 104. It should be noted that preset binary image data that is included in binary image data of a specific area may be displayed in the teacher data display section 1402 in order to reduce man-hour required to generate the teacher data.

The learning data setting module 512 determines whether an instruction to set learning data has been received via the API (Step S1502).

When it is determined that an instruction to set learning data has not been received, the learning data setting module 512 ends the setting processing. The alearning data setting module 512 at this point transmits a completion notification to the learning data generation module 112.

When it is determined that an instruction to set learning data has been received, the learning data setting module 512 updates the learning data management information (Step S1503), and then ends the setting processing. The learning data setting module 512 at this point transmits a completion notification to the learning data generation module 112.

FIG. 16 is a flow chart for illustrating the degradation evaluation processing, which is executed by the computer 100 according to the second embodiment.

The degradation evaluation module 511 sets the model information 121 generated by the learning processing to the learning module 113 (Step S1601).

Next, evaluation data stored in the evaluation data management information 523 and the learning data 205 generated by the learning data generation module 112 are input to the image processing module 111 (Step S1602).

The degradation evaluation module 511 next obtains the output data 203 from the image processing module 111 (Step S1603).

The degradation evaluation module 511 next uses the output data 203 and others to calculate an evaluation index of the model information 121 (Step S1604). For example, a value that indicates the precision of character recognition conducted on the binary image data is calculated as the evaluation index. This invention is not limited by the type and number of calculated evaluation indices.

The degradation evaluation module 511 next determines whether standard performance is fulfilled, based on the evaluation index (Step S1605). The degradation evaluation module 511 determines that the standard performance is fulfilled when, for example, average values (evaluation indices) of recall rates and precision rates of white and black pixels in pieces of image data exceed a threshold. It should be noted that this invention is not limited by the settings of the standard performance.

When it is determined that the standard performance is not fulfilled, the degradation evaluation module 511 sets the current piece of model information 121 to the image processing module 111 (Step S1606), and then ends the degradation evaluation processing. In this case, the model information 121 used by the image processing module 111 is not updated.

When it is determined that the standard performance is fulfilled, the degradation evaluation module 511 ends the degradation evaluation processing. In this case, the model information 121 used by the image processing module 111 is replaced with the newly generated piece of model information 121.

According to the second embodiment, the computer 100 is capable of generating the learning data 205 for generating the model information 121 from which an ultimate processing result that fulfills the user's demand is yielded.

In addition, efficient learning processing is accomplished by generating the learning data 205 from data that has yielded a processing result that does not fulfill the user's demand.

The present invention is not limited to the above embodiment and includes various modification examples. In addition, for example, the configurations of the above embodiment are described in detail so as to describe the present invention comprehensibly. The present invention is not necessarily limited to the embodiment that is provided with all of the configurations described. In addition, a part of each configuration of the embodiment may be removed, substituted, or added to other configurations.

A part or the entirety of each of the above configurations, functions, processing units, processing means, and the like may be realized by hardware, such as by designing integrated circuits therefor. In addition, the present invention can be realized by program codes of software that realizes the functions of the embodiment. In this case, a storage medium on which the program codes are recorded is provided to a computer, and a CPU that the computer is provided with reads the program codes stored on the storage medium. In this case, the program codes read from the storage medium realize the functions of the above embodiment, and the program codes and the storage medium storing the program codes constitute the present invention. Examples of such a storage medium used for supplying program codes include a flexible disk, a CD-ROM, a DVD-ROM, a hard disk, a solid state drive (SSD), an optical disc, a magneto-optical disc, a CD-R, a magnetic tape, a non-volatile memory card, and a ROM.

The program codes that realize the functions written in the present embodiment can be implemented by a wide range of programming and scripting languages such as assembler, C/C++, Perl, shell scripts, PHP, and Java.

It may also be possible that the program codes of the software that realizes the functions of the embodiment are stored on storing means such as a hard disk or a memory of the computer or on a storage medium such as a CD-RW or a CD-R by distributing the program codes through a network and that the CPU that the computer is provided with reads and executes the program codes stored on the storing means or on the storage medium.

In the above embodiment, only control lines and information lines that are considered as necessary for description are illustrated, and all the control lines and information lines of a product are not necessarily illustrated. All of the configurations of the embodiment may be connected to each other.

What is claimed is:

1. A computer, which is configured to generate learning data for use in machine learning for generating model information to be set to a system that is configured to generate second output data from first output data, the first output data being generated by processing input data with use of the model information,
the computer including a processor, a storage device to be coupled to the processor, and an interface to be coupled to the processor,
the processor being configured to:
obtain analysis input data;
generate, from the analysis input data, first to-be-analyzed output data based on an arbitrary generation condition;
generate second to-be-analyzed output data from the first to-be-analyzed output data;
analyze the second to-be-analyzed output data; and
generate, as the learning data, data including the analysis input data and the first to-be-analyzed output data in a case where the second to-be-analyzed output data fulfills a user's demand.

2. The computer according to claim 1, wherein the processor is configured to obtain, as the analysis input data, the input data from which the first output data used to generate the second output data that is output from the system and that does not satisfy the user's demand is generated.

3. The computer according to claim 1, wherein the processor is configured to:
generate the first to-be-analyzed output data from element data included in the analysis input data; and
generate, as the learning data, data including the element data and the first to-be-analyzed output data in a case where the second to-be-analyzed output data generated from the first to-be-analyzed output data fulfills the user's demand.

4. The computer according to claim 1, wherein the processor is configured to generate the first to-be-analyzed output data based on an algorithm different from an algorithm that is defined by the model information.

5. The computer according to claim 1,
wherein the storage device is configured to store evaluation input data, and
wherein the processor is configured to:
generate new model information by executing learning processing that uses the learning data;
generate the second output data from the first output data that is generated by processing the evaluation input data with use of the new model information;
analyze the second output data to calculate an index for evaluating quality of the new model information; and
determine whether the new model information is to be saved based on the index.

6. A method of generating learning data for use in machine learning for generating model information to be set to a system that is configured to generate second output data from first output data, the method being executed by a computer, the first output data being generated by processing input data with use of the model information,
the computer including a processor, a storage device to be coupled to the processor, and an interface to be coupled to the processor,
the method of generating learning data including:
a first step of obtaining, by the processor, analysis input data;
a second step of generating, by the processor, from the analysis input data, first to-be-analyzed output data based on an arbitrary generation condition;
a third step of generating, by the processor, second to-be-analyzed output data from the first to-be-analyzed output data;
a fourth step of analyzing, by the processor, the second to-be-analyzed output data; and
a fifth step of generating, by the processor, as the learning data, data including the analysis input data and the first to-be-analyzed output data in a case where the second to-be-analyzed output data fulfills a user's demand.

7. The method of generating learning data according to claim 6, wherein the first step includes a step of obtaining, by the processor, as the analysis input data, the input data from which the first output data used to generate the second output data that is output from the system and that does not satisfy the user's demand is generated.

8. The method of generating learning data according to claim 6,
wherein the second step includes a step of generating, by the processor, the first to-be-analyzed output data from element data included in the analysis input data, and
wherein the fifth step includes a step of generating, as the learning data, data including the element data and the first to-be-analyzed output data in a case where the second to-be-analyzed output data generated from the first to-be-analyzed output data fulfills the user's demand.

9. The method of generating learning data according to claim 6, wherein the processor is configured to generate the first to-be-analyzed output data based on an algorithm different from an algorithm that is defined by the model information.

10. The method of generating learning data according to claim 6,
wherein the storage device is configured to store evaluation input data, and
wherein the method of generating learning data includes:
generating, by the processor, new model information by executing learning processing that uses the learning data;
generating, by the processor, the second output data from the first output data that is generated by processing the evaluation input data with use of the new model information;
analyzing, by the processor, the second output data to calculate an index for evaluating quality of the new model information; and
determining, by the processor, whether the new model information is to be saved based on the index.

11. A computer system, comprising a plurality of computers,
the plurality of computers each including a processor, a storage device to be coupled to the processor, and an interface to be coupled to the processor,
the plurality of computers including a first computer and a second computer, the first computer being configured to execute processing of generating second output data from first output data, the first output data being generated by processing input data with use of model information, the second computer being configured to generate learning data for use in machine learning for generating the model information,
the second computer being configured to:
obtain analysis input data;
generate, from the analysis input data, first to-be-analyzed output data based on an arbitrary generation condition;
generate second to-be-analyzed output data from the first to-be-analyzed output data;
analyze the second to-be-analyzed output data; and
generate, as the learning data, data including the analysis input data and the first to-be-analyzed output data in a case where the second to-be-analyzed output data fulfills a user's demand.

12. The computer system according to claim 11, wherein the second computer is configured to obtain, as the analysis input data, the input data from which the first output data used to generate the second output data that is output from the first computer and that does not satisfy the user's demand is generated.

13. The computer system according to claim 11, wherein the second computer is configured to:
generate the first to-be-analyzed output data from element data included in the analysis input data; and
generate, as the learning data, data including the element data and the first to-be-analyzed output data in a case where the second to-be-analyzed output data generated from the first to-be-analyzed output data fulfills the user's demand.

14. The computer system according to claim 11, wherein the second computer is configured to generate the first to-be-analyzed output data based on an algorithm different from an algorithm that is defined by the model information.

15. The computer system according to claim 11,
wherein the second computer is configured to manage evaluation input data,
wherein the second computer is configured to:
generate new model information by executing learning processing that uses the learning data; and
output the evaluation input data to the first computer,
wherein the first computer is configured to:
generate the second output data from the first output data that is generated by processing the evaluation input data based on the new model information; and
output the second output data to the second computer, and
wherein the second computer is configured to:
analyze the second output data generated from the evaluation input data to calculate an index for evaluating quality of the new model information; and
determine whether the new model information is to be applied based on the index.
